(19) United States
(12) Patent Application Publication
(10) Pub. No.: US 2009/0063191 A1
(43) Pub. Date: Mar. 5, 2009

(54) Managing a patient injured in an emergency incident

(76) Inventors: Reuben C. Vasquez, Gurnee, FL (US); Harry B. James, Emmaus, PA (US); Michael A. Vasquez, Wadsworth, IL (US)

Correspondence Address: ANDREW L. NEY, 4 ANDORRA HILL, LAFAYETTE HILL, PA, 19444, US

(21) Appl. No.: 11/895,762

(22) Filed: Aug. 27, 2007

(51) Int. Cl. G06F 19/00

(52) U.S. Cl. 705/3; 235/375

(57) ABSTRACT

A method and system employed by emergency responders to an emergency incident in the management of individuals injured in emergency incidents. An injured patient is tagged with a triage tag that has a bar code and an RFID inlay that identify the patient. At least one of the bar code and RFID inlay are scanned by a portable optical/electronic unit. As the patient is moved through various zones in which the condition of the patient is evaluated and, if necessary, the condition of the patient is treated, patient evaluation data is recorded in the in the portable optical/electronic unit and a command computer in association with patient identification data.

### FIELD OF THE INVENTION

The present invention relates, in general, to services performed by responders to emergency incidents and, in particular, to a method and system employed by responders to an emergency incident in the management of individuals injured in emergency incidents.

### BACKGROUND OF THE INVENTION

Emergency incidents, such as a fire, a building collapse, or a bombed building, whether caused by an act of nature, human error, or an act of a terrorist, are of tremendous concern at the present time. One major aspect of this concern is the management of individuals injured in the emergency incident.

Currently, there are many different procedures practiced and equipment employed by responders to an emergency incident in the management of individuals injured in the incident. The management of an individual injured in an emergency incident requires a quick and accurate assessment of the condition of the individual and, if necessary, quick and proper treatment of the condition. In addition, of major importance is keeping track of the injured individual, his or her condition, and his or her location.

It is apparent that the tasks of the responders to an emergency incident, in managing individuals injured in the incident, become more difficult the greater the number of injured individuals. Consequently, there is an ongoing effort to improve the procedures and systems that are practiced and used by the responders.

### SUMMARY OF THE INVENTION

According to the present invention, a patient, injured in an emergency incident, is managed by emergency responders that use a system that includes a plurality of wireless electronic transmitter/receiver communications units placed at selected locations in the site of an emergency incident to establish a wireless electronic communications network. A triage tag, having a bar code and an RFID inlay, with each containing patient identity data that identifies a selected patient in the selected area, is placed on the selected patient while the patient is in a patient identification zone. A first patient evaluation of the condition of the selected patient is conducted by an emergency responder and, if necessary, the condition of the selected patient is treated. First patient evaluation data is recorded on the triage tag by the emergency responder. The emergency responder, using a wireless optical/electronic transmitter/receiver reader, scans at least one of the bar code and the RFID inlay of the triage tag of the selected patient and records the patient identity data and the first patient evaluation data in the reader. The patient identity data and the first patient evaluation data are transmitted from the reader to a transmitter/receiver in a command computer via the communications units of the communications network and are recorded in the command computer. When a second patient evaluation of the condition of the selected patient is conducted by a second emergency responder in a patient treatment zone, a second wireless optical/electronic transmitter/receiver reader receives from transmitter/receiver of the command computer via the communications units of the communications network, the patient identity data and the first patient evaluation data. After a second patient evaluation is conducted and the condition of the selected patient is treated, second patient evaluation data is recorded on the triage tag and in the second reader and the patient identity data and the second patient evaluation data are transmitted from the reader to the transmitter/receiver of the command computer via the communications units of the communications network and are recorded in the command computer.

### BRIEF DESCRIPTION OF THE DRAWINGS

FIG. 1 is a flow chart of a preferred embodiment of a method for managing a patient injured in an emergency incident according to the present invention.

FIG. 2 is a diagram of a preferred embodiment of a system for managing a patient injured in an emergency incident according to the present invention.

FIGS. 3A and 3B are front and back views, respectively, of a triage tag particularly useful in the system illustrated in FIG. 2.

FIGS. 4A through 4F illustrate examples of drop-down menus that can be incorporated in wireless optical/electronic transmitter/receiver readers used in the FIG. 2 system.

FIG. 5 is a sectional view of an RFID inlay that can be incorporated in a triage tag used in the method and system for managing a patient injured in an emergency incident according to the present invention.

### DETAILED DESCRIPTION OF THE INVENTION

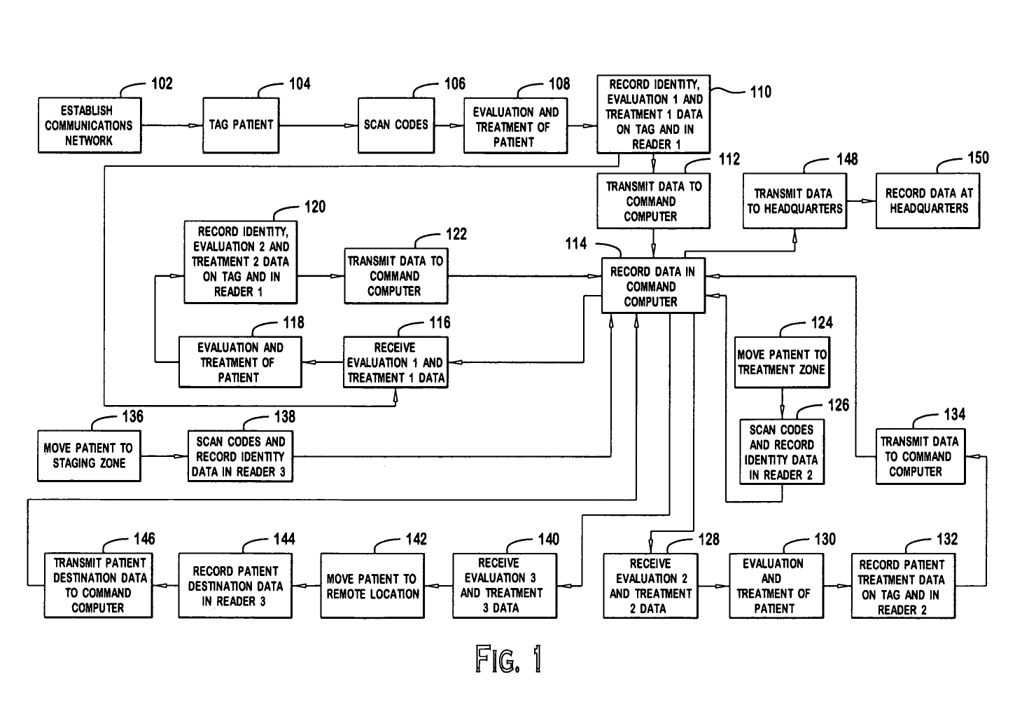

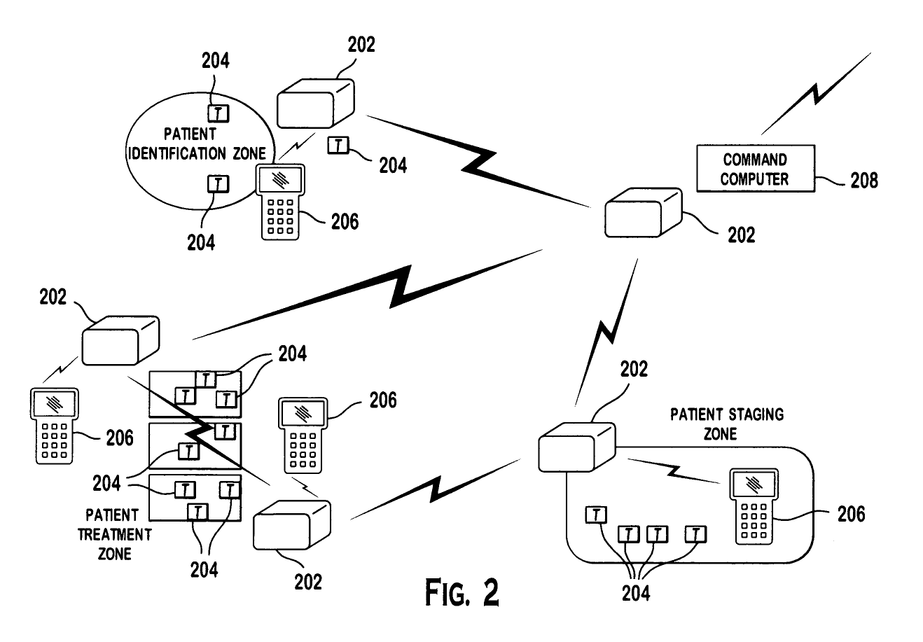

Referring to FIGS. 1 and 2, a patient, injured in an emergency incident, is managed by emergency responders according to the present invention by first placing a plurality of wireless electronic transmitter/receiver communications units at selected locations in the site of an emergency incident to establish a wireless electronic communications network. This is represented by step 102 in the flow chart of FIG. 1 and the transmitter/receiver communications units 202 in FIG. 2. These transmitter/receiver units can be of conventional construction and operation, such as the commercially available units known as BreadCrumbs® sold by Rajant Corporation.

A triage tag 204, shown in FIG. 2, is placed on the selected patient while the patient is in a patient identification zone, commonly referred to as the “hot zone.” This is represented by step 104 in the flow chart of FIG. 1.

Triage tags in use at the present time, such as EMS Disaster Tags sold by Disaster Management Systems, Inc., have a unique bar code that contains patient identity data that identifies a selected patient in the selected area. In other words, each such bar code represents unique data that is individually associated with a selected patient injured in an emergency incident and this unique data serves to identify the selected patient. The bar code is scanned by a wireless optical transmitter/receiver reader to record the patient identity data.

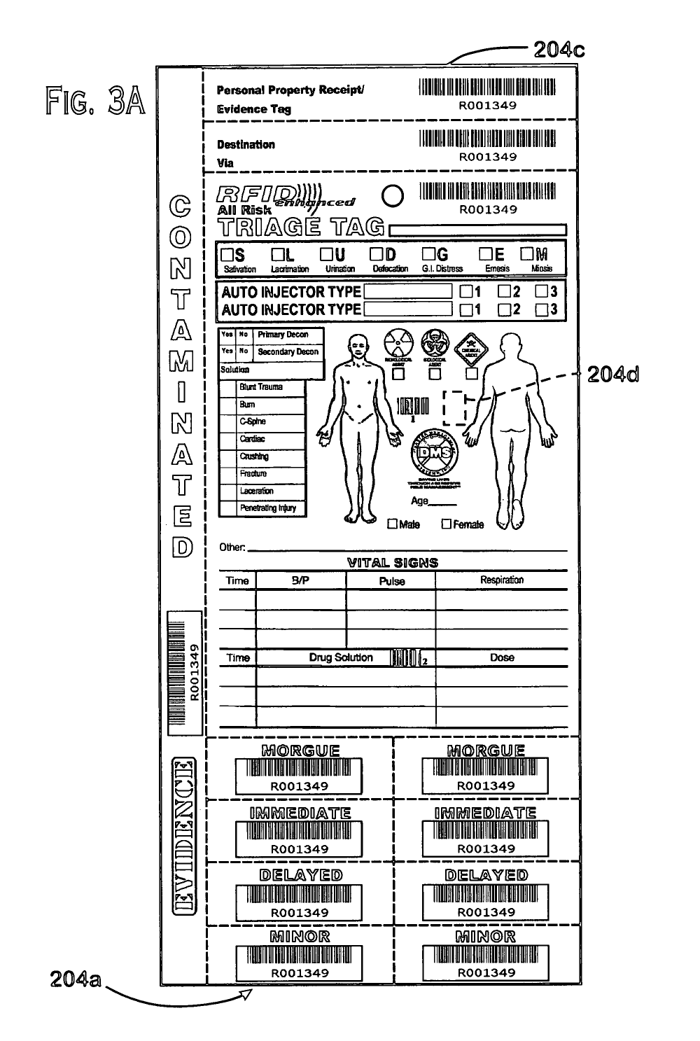

As shown in FIGS. 3A and 3B, a triage tag 204 that is used in the present invention has front and back sheets 204a and 204b, respectively. A bar code 204c is printed on a plurality of separable parts. Triage tag 204 has, in addition to bar code 204c, an RFID inlay 204d, shown by dotted lines, that is disposed between the front and back sheets 204a and 204b and contains the same unique data as in the bar code, thereby serving as another source of patient identity data that identifies the selected patient when either the bar code or the RFID inlay is scanned by a wireless optical/electronic transmitter/receiver reader. This is represented by step 106 in the flow chart of FIG. 1 and readers 206 in FIG. 2. Reader 206 can be of conventional construction and operation, such as Symbol RFID Barcode Mobile Scanners made by Motorola, Inc., that are programmed with software appropriate for the particular application. It will be understood that it is not necessary to scan both the RFID inlay and the bar code to record the patient identity data. The preferred mode of operation is to scan the RFID inlay in the first instance and scan the bar code if the RFID inlay scanning operation fails.

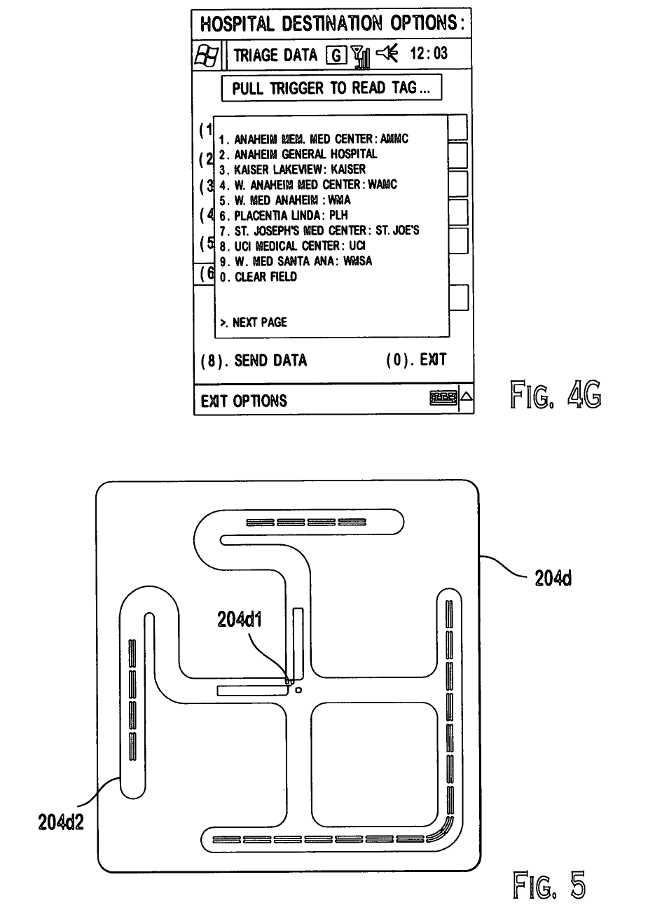

FIG. 5 is a sectional view of an RFID inlay 204d that can be incorporated in triage tag 204. RFID inlay 204d in FIG. 5 can be of standard design that includes a chip 204d1 and an antenna 204d2 connected to the chip.

While the selected patient is in the patient identification area, a patient evaluation of the condition of the selected patient is conducted by an emergency responder and, if necessary, the condition of the selected patient is treated. This is represented by step 108 in the flow chart of FIG. 1.

Patient evaluation data is recorded on triage tag 204 in FIG. 2 by the emergency responder and in reader 206 by the emergency responder. If desired, the FIG. 2 system can be arranged to record patient treatment data that represents the treatment provided the patient if treatment has been provided. This is represented by step 110 in the flow chart of FIG. 1.

The recorded patient identity data and the recorded first patient evaluation data (along with recorded first patient treatment, if any) are transmitted from reader 206 to a transmitter/receiver in a command computer 208 via the communications units 202 of the communications network. The data transmitted to command computer 208 is recorded in the command computer. This is represented by steps 112 and 114 in the flow chart of FIG. 1.

When a second patient evaluation of the condition of the selected patient is conducted, the reader has, or receives from the transmitter/receiver of command computer 208 via communications units 202 of the communications network, the patient identity data and the first patient evaluation data, along with patient treatment data if available and desired. This is represented by step 116 in the flow chart of FIG. 1. Preferably, the patient identity data, the first patient evaluation data, and the first patient treatment data, if available and desired, are accessed from reader 206 or received from command computer 208 prior to conducting a second patient evaluation of the patient and administering further treatment, if necessary, to the patient.

As represented by step 118 in the flow chart of FIG. 1, a second evaluation of the condition of the selected patient can be conducted and, if necessary, the condition of the selected patient is treated further. The second patient evaluation data is recorded on triage tag 204 and in reader 206. This is represented by step 120 in the flow chart of FIG. 2.

The patient identity data and the second patient evaluation data are transmitted from reader 206 to the transmitter/receiver of command computer 208 via the communications units 202 of the communications network and are recorded in the command computer. If the FIG. 2 system is arranged to record patient treatment data, second patient treatment data also can be transmitted to command computer 208 and recorded in the command computer. This is represented by steps 122 and 114 in the flow chart of FIG. 1.

After the selected patient has been identified and the condition of the selected patient has been evaluated and, if necessary, treated, the selected patient is moved from the patient identification zone to a patient treatment zone, commonly referred to as the “triage zone, where the condition of the selected is treated, if further treatment is necessary. This is represented by step 124 in the flow chart of FIG. 1.

A second emergency provider, having a second wireless optical/electronic transmitter/receiver reader 206, manages the selected patent in the patient treatment zone. The second emergency provider scans at least one of the RFID inlay and the bar code of triage tag 204 of the selected patient with the second reader to record in the second reader the patient identity data. This is represented by step 126 in the flow chart of FIG. 1.

By accessing command computer 208 prior to treating the selected patient in the patient treatment zone, the patient evaluation data and the patient treatment data, if any, recorded in the command computer is received in second reader 206. This is represented by step 128 in the flow chart of FIG. 1.

The second emergency provider conducts a patient evaluation of the condition of the selected patient in the patient treatment zone and, if necessary, treats the condition of the selected patient in the patient treatment zone. This is represented by step 130 in the flow chart of FIG. 1.

The patient evaluation data developed from the patient evaluation conducted in the patient treatment zone is recorded on the triage tag and in the second reader 206 and the patient identity data and this patient evaluation data are transmitted from second reader 206 to the transmitter/receiver of command computer 208 via communications units 202 of the communications network for recording in the command computer. If the FIG. 2 system is arranged to record patient treatment data representative of the treatment received by the selected patient in the patient treatment zone, patient treatment data is recorded in second reader 206 and transmitted to the transmitter/receiver of command computer 208 and via communications units 202 of the communications network for recording in the command computer. This is represented by steps 132, 134, and 114 of the flow chart of FIG. 1.

After the selected patient has been evaluated and treated in the patient treatment zone, the selected patient is moved to a patient staging zone from where the selected patient is transported to a remote destination for further treatment. This is represented by step 136 in the flow chart of FIG. 1. It should be understood that, if the evaluation of the selected patient in the patient identification zone leads to the conclusion that the selected patient does not require treatment, the selected patient can be moved directly from the patient identification zone to the patient staging zone if the users of the system contemplate such flexibility in their management of patients.

A third emergency provider, having a third wireless optical/electronic transmitter/receiver reader 206, manages the selected patent in the patient staging zone. The third emergency provider scans at least one of the bar code and the RFID inlay of triage tag 204 of the selected patient with the third reader to record in the third reader the patient identity data. This is represented by step 138 in the flow chart of FIG. 1.

By accessing command computer 208 prior to transporting the selected patient to a remote location, patient evaluation data and patient treatment data, if any has been recorded, is received in third reader 206. This is represented by step 140 in the flow chart of FIG. 1.

The selected patient then is transported to a remote destination which is represented by step 142 of the flow chart of FIG. 1. Patient destination data of the remote destination to which the selected patient is transported and patient transport data of the transport means (e.g., ambulance identification) by which the patient is being transported to the remote destination is recorded in third reader 206. This is represented by step 144 in the flow chart of FIG. 1.

The patient identity data, patient destination data, and patient transport data are transmitted from third reader 206 to the transmitter/receiver of the command computer 208 via the communications units 202 of the communications network. This is represented by step 146 of the flow chart in FIG. 1. The patient identity data, patient destination data and patient transport data are recorded in command computer 208 as represented by step 114 of the flow chart of FIG. 1.

Data recorded in command computer 208 can be transmitted to a central location or headquarters, such as a city hall, for recording. This is represented by steps 148 and 150 of the flow chart of FIG. 1.

It should be understood that labeling the patient evaluations and patient treatments in numerical sequence is done more to present the manner in which the present invention can be implemented rather than presenting how the present invention is practiced in all instances. As indicated above, if the evaluation of the selected patient in the patient identification zone is such that the selected patient does not require treatment, the selected patient can be moved directly from the patient identification zone to the patient staging zone. Likewise, if no further treatment of the selected patient in the patient identification zone is conducted, the second patient treatment, if necessary, will be performed in the patient treatment zone. The present invention is best implemented by providing the users, namely emergency responders, with equipment and methodology that has the most features and greatest flexibility to enable them to perform their tasks.

Preferably, each wireless optical/electronic transmitter/receiver reader 206 includes means for displaying drop-down menus having a plurality of data entry selections that display options for entering data associated with the selected patient, means for selecting a data entry option, and means for entering data associated with the selected patient selecting options. It will be understood that, in the following description of the entry of data into a wireless optical/electronic transmitter/receiver reader, the reader under consideration at any particular time is that reader being operated by the emergency responder at the particular location within the site of the emergency event (i.e., “Patient Identification Zone” or “Patient Treatment Zone” or “Patient Staging Zone”) where the data is being entered.

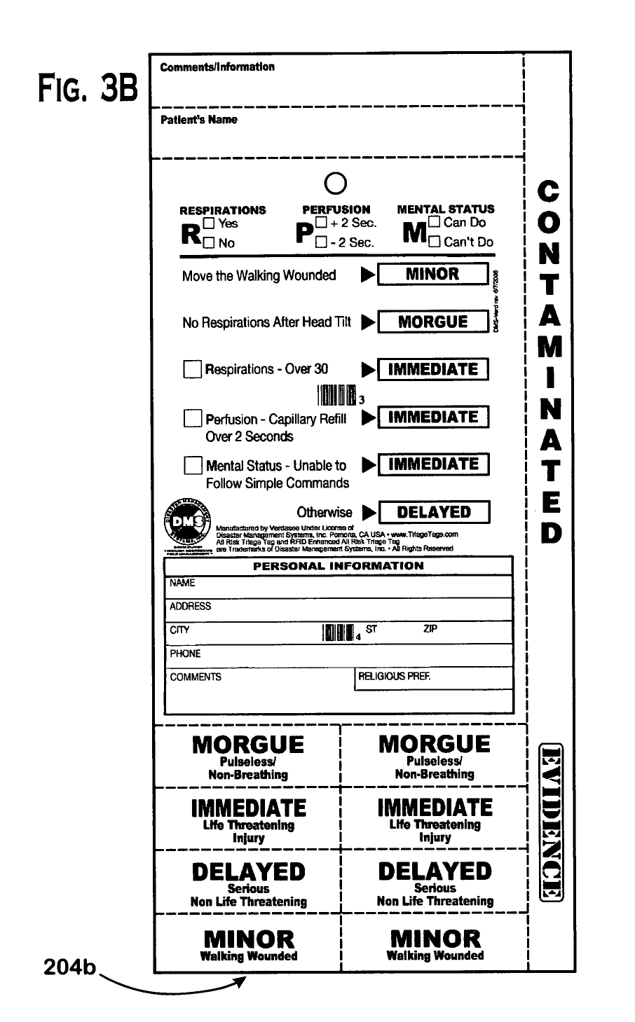

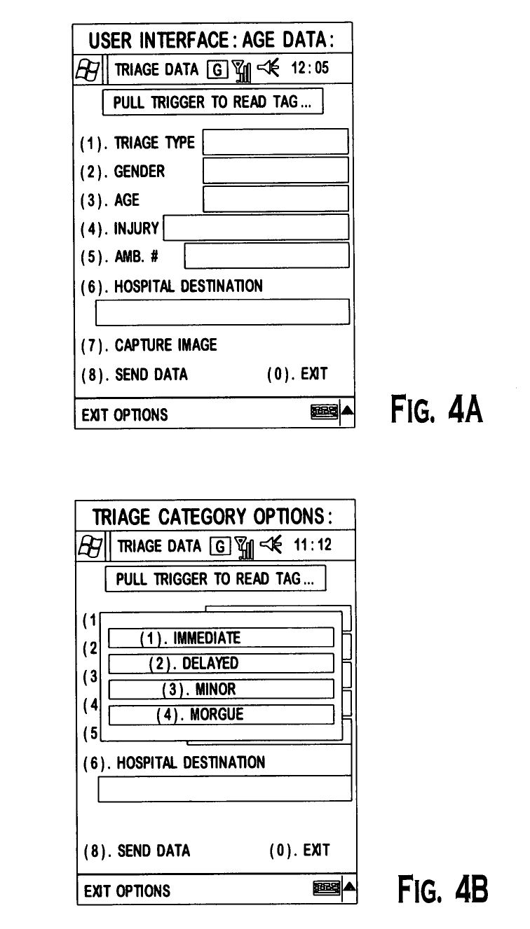

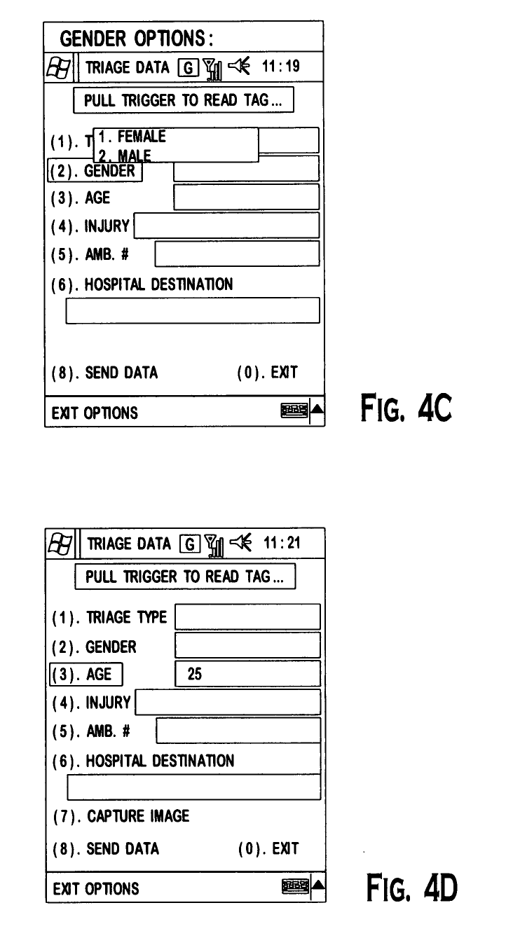

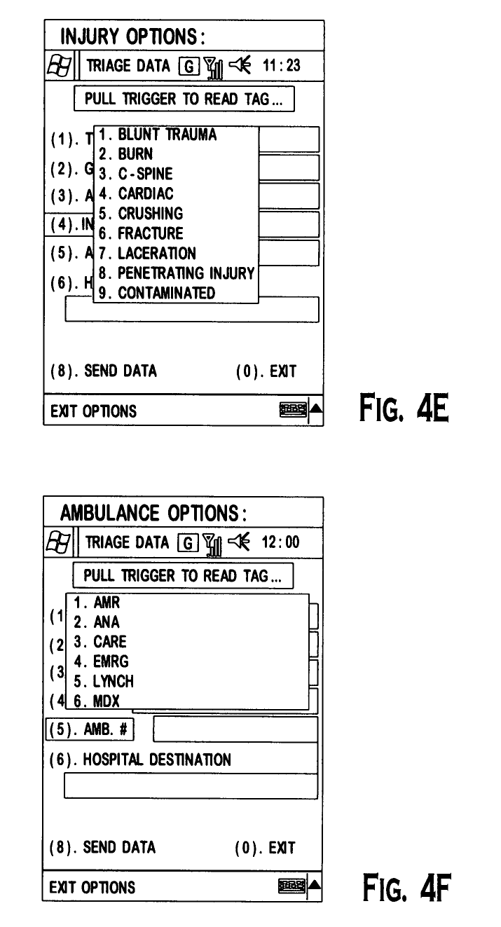

FIG. 4A illustrates a user interface screen of a wireless optical/electronic transmitter/receiver reader of the data entry options available to an emergency responder for entering data about the selected patient. Upon activation of the “Pull Trigger To Read Tag” block by the emergency responder by engaging an appropriate control on the reader, the scanning by the reader of the RFID inlay in the triage tag (i.e., “patient identity data”) is automatically entered in this block.

When the emergency responder engages the appropriate character(s) on the key pad of the wireless optical/electronic transmitter/receiver reader that correspond to the “(1) Triage Type” option, the “Triage Category Options” screen illustrated in FIG. 4B appears on the reader. The “Triage Category Options” “(1) Immediate” or “(2) Delayed” or “(3) Minor” or (4) Morgue”) that are displayed on the reader screen correspond to the “EVIDENCE” options on triage tag 204 illustrated in FIGS. 3A and 3B. The emergency responder enters data of the triage category option (i.e., “patient evaluation data”) by engaging the appropriate character(s) on the key pad of the reader that correspond to the triage category option that is selected.

When the emergency responder engages the appropriate character(s) on the key pad of the wireless optical/electronic transmitter/receiver reader that correspond to the “(2) Gender” option, the “Gender Options” screen illustrated in FIG. 4C appears on the reader. The emergency responder enters the gender of the selected patient (i.e., “patient identity data”) by engaging the appropriate character(s) on the key pad of the reader that correspond to the gender of the selected patient.

When the emergency responder engages the appropriate character(s) on the key pad of the wireless optical/electronic transmitter/receiver reader that correspond to the “(3) Age” option, the “Age Data” screen illustrated in FIG. 4D appears on the reader. The emergency responder enters the age of the selected patient (i.e., “patient identity data”) by manually entering the age of the selected patient by engaging the character(s) on the key pad of the reader that correspond to the age of the selected patient.

When the emergency responder engages the appropriate character(s) on the key pad of the wireless optical/electronic transmitter/receiver reader that corresponds to the “(4) Injury” option, the “Injury Options” screen illustrated in FIG. 4E appears on the reader. The emergency responder enters the nature of the injury sustained by the selected patient (i.e., “patient evaluation data”) by engaging the character(s) on the key pad of the reader that correspond to the nature of the injury sustained by the selected patient.

When the emergency responder engages the appropriate character(s) on the key pad of the wireless optical/electronic transmitter/receiver reader that corresponds to the “(5) Amb. #” option, the “Ambulance Options” screen illustrated in FIG. 4F appears on the reader. With a listing of the ambulance services that operate in the geographical area in which the emergency incident occurred, the emergency responder enters the particular ambulance service by which the selected patient is being transported to the remote location (i.e., “patient transport data”) by engaging the appropriate character(s) on the key pad of the reader that correspond to particular ambulance service and the emergency responder manually enters the number of the ambulance in which the selected patient is being transported to the remote destination by engaging the appropriate character(s) on the key pad of the reader that correspond to the ambulance number.

When the emergency responder engages the appropriate character(s) on the key pad of the reader that corresponds to the “(6) Hospital Destination” option, the “Hospital Destination Options” screen illustrated in FIG. 4G appears on the reader. With a listing of the hospitals that operate in the geographical area in which the emergency incident occurred, the emergency responder enters the particular hospital to which the selected patient is being transported (i.e., “patient destination data”) by engaging the appropriate character(s) on the key pad of the reader that correspond to the particular hospital.

After data has been entered into a wireless optical/electronic transmitter/receiver reader at a particular location (i.e., “Patient Identification Zone” or “Patient Treatment Zone” or “Patient Staging Zone”), that data is transmitted to the command computer by engaging the appropriate character(s) on the key pad of the reader corresponding to the “(8) Send Data” option that appears on all of the screens described above and illustrated in the drawings.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for managing a patient injured in an emergency incident comprising the steps of:
placing a plurality of wireless electronic transmitter/receiver communications units at selected locations in the site of an emergency incident to establish a wireless electronic communications network;
providing a triage tag having a bar code and an RFID inlay each containing patient identity data that identifies a selected patient in the selected area;
placing the triage tag on the selected patient;
conducting a first patient evaluation of the condition of the selected patient;
recording first patient evaluation data on the triage tag;
providing a wireless optical/electronic transmitter/receiver reader;
scanning at least one of the bar code and the RFID inlay of the triage tag of the selected patient with the reader to record in the reader the patient identity data;
recording the first patient evaluation data in the reader;
providing a command computer having a wireless transmitter/receiver;
transmitting the patient identity data and the first patient evaluation data from the reader to the transmitter/receiver of the command computer via the communications units of the communications network;
recording the patient identity data and the first patient evaluation data in the command computer;
conducting a second patient evaluation of the condition of the selected patient;
recording second patient evaluation data in the reader;
transmitting the patient identity data and the second patient evaluation data from the reader to the transmitter/receiver of the command computer via the communications units of the communications network; and
recording the patient identity data and the second patient evaluation data in the command computer.

2. A method for managing a patient injured in an emergency incident according to claim 1 further including the steps of:
(a) accessing the patient identity data and the first patient evaluation data recorded in the command computer prior to conducting the second patient evaluation;
(b) receiving in the reader the patient identity data and the first patient evaluation data prior to conducting the second patient evaluation.

3. A method for managing a patient injured in an emergency incident according to claim 1:
(a) wherein the reader is operated by a first emergency responder managing the selected patient in a patient identification zone where the selected patient is identified and the first patient evaluation is conducted; and
(b) the method further includes the steps of:
(1) moving the selected patient to a patient treatment zone where the condition of the selected patient is treated,
(2) providing a second wireless optical/electronic transmitter/receiver reader operated by a second emergency responder managing the selected patent in the patient treatment zone,
(3) scanning at least one of the bar code and the RFID inlay of the triage tag of the selected patient with the second reader to record in the second reader the patient identity data,
(4) receiving in the second reader the first patient evaluation data prior to treating the selected patient in the patient treatment zone,
(5) conducting a second patient evaluation of the condition of the selected patient in the patient treatment zone,
(6) conducting treatment of the condition of the selected patient in the patient treatment zone,
(7) recording the second patient evaluation data in the second reader,
(8) transmitting the patient identity data and the second patient evaluation data from the second reader to the transmitter/receiver of the command computer via the communications units of the communications network, and
(9) recording the patient identity data and the second patient evaluation data in the command computer.

4. A method for managing a patient injured in an emergency incident according to claim 3 further including the steps of:
(a) moving the selected patient to a patient staging zone from where the selected patient is transported to a remote destination for further treatment;
(b) providing a third wireless optical/electronic transmitter/receiver reader operated by a third emergency responder managing the selected patent in the patient staging zone;
(c) scanning at least one of the bar code and the RFID inlay of the triage tag of the selected patient to record in the third reader the patient identity data;
(d) receiving in the third reader the second patient evaluation data prior to transporting the selected patient to the remote destination;
(e) transporting the selected patient to the remote destination;
(f) recording patient destination data of the remote destination to which the selected patient is transported and patient transport data of the transport means by which the patient is being transported to the remote destination in the third reader and;
(g) transmitting the patient identity data, the patient destination data, and the patient transport data from the third reader to the transmitter/receiver of the command computer via the communications units of the communications network;
(h) recording the patient identity data, the patient destination data, and the patient transport data in the command computer;
(i) transmitting the patient identity data, the patient evaluation data, the patient destination data, and the patient transport data from the command computer to a headquarters facility; and
(j) recording the patient identity data, the patient evaluation data, the patient destination data, and the patient transport data at the headquarters facility.

5. A method for managing a patient injured in an emergency incident according to claim 3 further including the steps of:
(a) recording patient treatment data in the second reader;
(b) transmitting the patient treatment data from the second reader to the transmitter/receiver of the command computer via the communications units of the communications network; and
(c) recording the patient treatment data in the command computer.

6. A method for managing a patient injured in an emergency incident according to claim 5 further including the steps of:
(a) conducting patient treatment of the condition of the selected patient while the selected patient is in the patient identification zone;
(b) recording patient treatment data of the treatment of the selected patient conducted while the selected patient is in the patient identification zone in the reader operated by the first emergency responder;
(c) transmitting the patient treatment data from the reader operated by the first emergency responder to the transmitter/receiver of the command computer via the communications units of the communications network; and
(d) recording the patient treatment data transmitted from the reader operated by the first emergency responder in the command computer.

7. A system for managing a patient injured in an emergency incident comprising:
a wireless electronic communications network including a plurality of wireless electronic transmitter/receiver communications units disposed at selected locations in the site of an emergency incident;
a triage tag having a bar code and an RFID inlay each containing patient identity data that identifies a selected patient in the selected area;
a wireless optical/electronic transmitter/receiver reader having:
(a) means for scanning at least one of the bar code and the RFID inlay of the triage tag of the selected patient to record the patient identity data of the selected patient,
(b) means for recording patient evaluation data of the condition of the selected patient, and
(d) transmitting the patient identity data and the patient evaluation data from the reader to a command computer via the communications units of the communications network; and
a command computer having a wireless transmitter/receiver and data recording means for:
(a) receiving via the communications units of the communications network and the transmitter/receiver of the command computer the patient identity data and the patient evaluation data transmitted from the reader,
(b) recording in the data recording means the patient identity data and the patient evaluation data, and
(c) transmitting via the transmitter/receiver of the command computer and the communications units of the communications network the patient identity data and the patient evaluation data to the reader.

8. A system for managing a patient injured in an emergency incident according to claim 7:
(a) wherein the reader is operated by a first emergency responder managing the selected patient in a patient identification zone where the selected patient is identified; and
(b) the system further includes a second wireless optical/electronic transmitter/receiver reader operated by a second emergency responder managing the selected patent in a patient treatment zone where the selected patient is treated, said second reader having means for:
(1) scanning at least one of the bar code and the RFID inlay of the triage tag of the selected patient to record in the second reader the patient identity data,
(2) receiving from the data recording means in the command computer the patient evaluation data recorded in the command computer,
(3) recording in the second reader patient evaluation data received from the data recording means in the command computer and patient evaluation data developed while the patient is in the patient treatment zone, and
(4) transmitting the patient identity data and the patient evaluation data from the second reader to the transmitter/receiver of the command computer via the communications units of the communications network.

9. A system for managing a patient injured in an emergency incident according to claim 8 further including:
(a) a third wireless optical/electronic transmitter/receiver reader operated by a third emergency responder managing the selected patent in a patient staging zone from where the selected patient is transported to a remote destination for further treatment, said third reader for:
(1) scanning at least one of the bar code and the RFID inlay of the triage tag of the selected patient to record in the third reader the patient identity data,
(2) receiving from the data recording means in the command computer the patient evaluation data recorded in the command computer,
(3) recording patient destination data of the remote destination to which the selected patient is transported, and
(4) transmitting the patient identity data and the patient destination data from the third reader to the transmitter/receiver of the command computer via the communications units of the communications network; and
(b) means for recording the patient identity data and the patient destination data in the command computer.

10. A system for managing a patient injured in an emergency incident according to claim 9 wherein each of the readers include:
(a) means for displaying drop-down menus having a plurality of data entry selections that display options for entering data associated with the selected patient;
(b) means for selecting a data entry option; and
(c) means for entering data associated with the selected patient selecting options.

11. A system for managing a patient injured in an emergency incident according to claim according to claim 10 wherein:
(a) the second reader has means for:
(1) recording patient treatment data, and
(2) transmitting the patient treatment data to the transmitter/receiver of the command computer via the communications units of the communications network; and
(b) the command computer has means for recording the patient treatment data.

12. A method for managing a patient injured in an emergency incident according to claim 11 wherein:
(a) the reader operated by the first emergency responder has means for:
(1) recording patient treatment data, and
(2) transmitting the patient treatment data to the transmitter/receiver of the command computer via the communications units of the communications network; and
(b) the command computer has means for recording the patient treatment data transmitted from the reader operated by the first emergency responder.
